(19) United States
(12) Patent Application Publication
(10) Pub. No.: US 2025/0261692 A1
(43) Pub. Date: Aug. 21, 2025

(54) PERSONAL VAPORIZER CARTRIDGE WITH VISCOSITY CONTROL

(71) Applicant: Kyle D. Newton, Euless, TX (US)

(72) Inventor: Kyle D. Newton, Euless, TX (US)

(21) Appl. No.: 18/583,536

(22) Filed: Feb. 21, 2024

(51) Int. Cl. A24F 40/46; A24F 40/10; A24F 40/42; A24F 40/51; A24F 40/57; G05D 23/20; H05B 1/02

(52) U.S. Cl. CPC A24F 40/46; A24F 40/10; A24F 40/42; A24F 40/51; A24F 40/57; G05D 23/20; H05B 1/0244; H05B 2203/021

(57) ABSTRACT

The present disclosure describes systems, methods, and an apparatus for controlling fluid viscosity within a personal vaporizer such as an electronic cigarette, a vape pen, vape kits, e-cig, or e-hookah, electronic nicotine delivery system. The apparatus can include a cartridge for a personal vaporizer that has a reservoir for containing fluid to be vaporized, a first heater configured to vaporize the fluid, the first heater located in an atomization chamber, a wick configured to deliver the fluid from the first heater, a second heater configured to warm the fluid in the reservoir without vaporizing the fluid, and a set of contacts configured to receive power and deliver the power to the first heater and the second heater.

### BACKGROUND

Personal vaporizers provide an alternative to smoking techniques which involve combustion of organic matter and inhalation of the vapor. Instead, vaporizers atomize a substance (e.g., a nicotine substance or cannabis substance) using a heating element to simulate the combustion found in traditional cigarettes. Personal vaporizers often use removable/replaceable cartridges containing a substance for atomization. Different substances may require different heating profiles for improved vaporization.

### SUMMARY

The present disclosure involves systems, methods, and an apparatus for controlling fluid viscosity within a personal vaporizer such as an electronic cigarette, a vape pen, vape kits, e-cig, or e-hookah, electronic nicotine delivery system. The apparatus can include a cartridge for a personal vaporizer that has a reservoir for containing fluid to be vaporized, a first heater configured to vaporize the fluid, the first heater located in an atomization chamber, a wick configured to deliver the fluid from the first heater, a second heater configured to warm the fluid in the reservoir without vaporizing the fluid, and a set of contacts configured to receive power and deliver the power to the first heater and the second heater. Implementations can optionally include one or more of the following features.

In some instances, the second heater is configured to warm the fluid in the reservoir to no greater than 70° C.

In some instances, the apparatus includes a temperature sensor configured to generate a signal based on the temperature of the fluid in the reservoir but outside the atomization chamber. In some instances, the second heater is positioned on an outer surface of the atomization chamber, and the atomization chamber is within the reservoir.

In some instances, a puff sensor is included, the puff sensor configured to detect when airflow passes through the cartridge and output a puff signal.

In some instances, the second heater includes two conductors, a first conductor disposed along an outer diameter of the reservoir, and a second conductor disposed along an outer surface of the atomization chamber and along an inner diameter of the reservoir.

In some instances, the apparatus includes a power supply that has a battery, and a controller configured to receive the generated signal and deliver electrical power from the battery to the second heater to cause the second heater to warm the fluid. In some instances, the controller is configured to warm the fluid to a temperature less than 70° C. In some instances, the controller is configured to warm the fluid to a temperature of at least 26° C. In some instances, the controller delivers power to the second heater in an amount inversely proportional to the generated signal.

In some instances, the power supply portion and the cartridge portion are removably coupled together by a coupler, and the coupler includes a set of electrical contacts. In some instances, a first contact of the set of contacts is connected to the first heater, and a second contact of the set of contacts is connected to the second heater.

In some instances, a third contact of the set of contacts is connected to the temperature sensor.

The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 depicts a perspective view of an example implementation of a personal vaporizer.

FIG. 2 depicts a side view of an example personal vaporizer with a removable cartridge removed.

FIG. 3 illustrates a schematic diagram of some internal components of a personal vaporizer cartridge and power supply.

FIGS. 4A-4D illustrate example configurations of contacts for operation of a personal vaporizer cartridge.

### DETAILED DESCRIPTION

This disclosure describes a system and method of controlling fluid viscosity for a fluid within a personal vaporizer such as an electronic cigarette, a vape pen, vape kits, e-cig, or e-hookah, electronic nicotine delivery system. In some personal vaporizer implementations, a power supply portion operates a disposable cartridge portion. The cartridge includes a reservoir containing the substance to be vaporized, and a heating element. However, some substances may have different flow properties or viscosity and may not operate well within the cartridge over a wide range of ambient temperatures. This disclosure describes a system and techniques for enabling the power supply portion of a personal vaporizer to control the fluid viscosity within the cartridge, in order to ensure proper operation over a wide range of temperatures.

Certain substances that may be used in a personal vaporizer are solid or near-solid at relatively warm temperatures. These substances (e.g., THC oil) can be waxy, or highly viscous at ambient temperatures where vaporizer use is desirable. Because of this high viscosity, the substance may not flow well, and voids can form around the wick within the reservoir, causing “dry out” or a “burnt hit” where insufficient substance is wetting the wick of the device during use. One solution to encourage the fluid to flow freely to the wick and therefore into the atomization chamber is to pre-heat or otherwise warm the fluid in the cartridge reservoir. This lowers the substance's viscosity and improves overall performance. A warming coil (separate from the heating element that vaporizes the substance in the atomization chamber) can be provided in a reservoir where the fluid is stored. In some instances, the warming coil can be controlled to provide enough heat to soften or encourage flow of the substance in the reservoir, without causing any evaporation or boiling of the substance or otherwise overheating other components of the cartridge.

The use of a secondary warming coil to heat substance in the reservoir is advantageous in that it allows use of a broader range of substances with a personal vaporizer in a broader range of ambient temperatures. Additionally risk to the user is reduced in that they are less likely to cause overheating and damage to the wick material due to insufficient fluid flow during use.

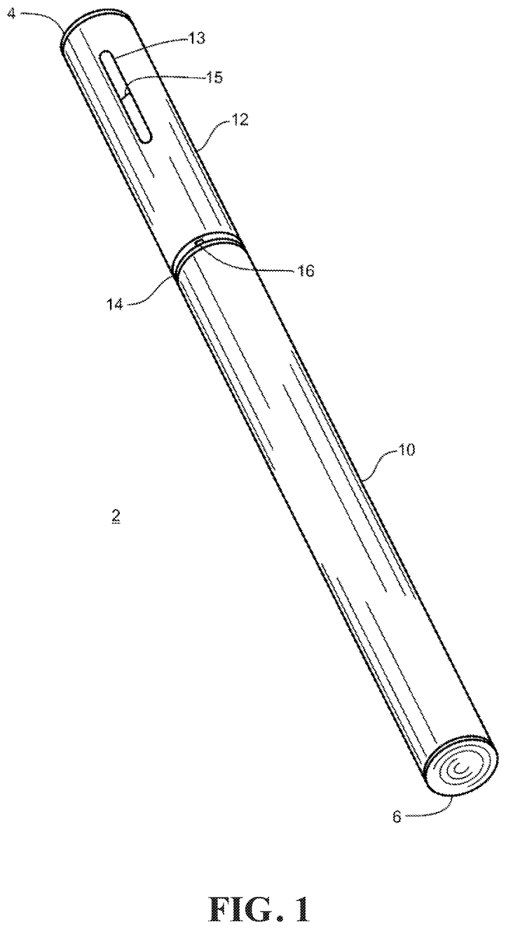

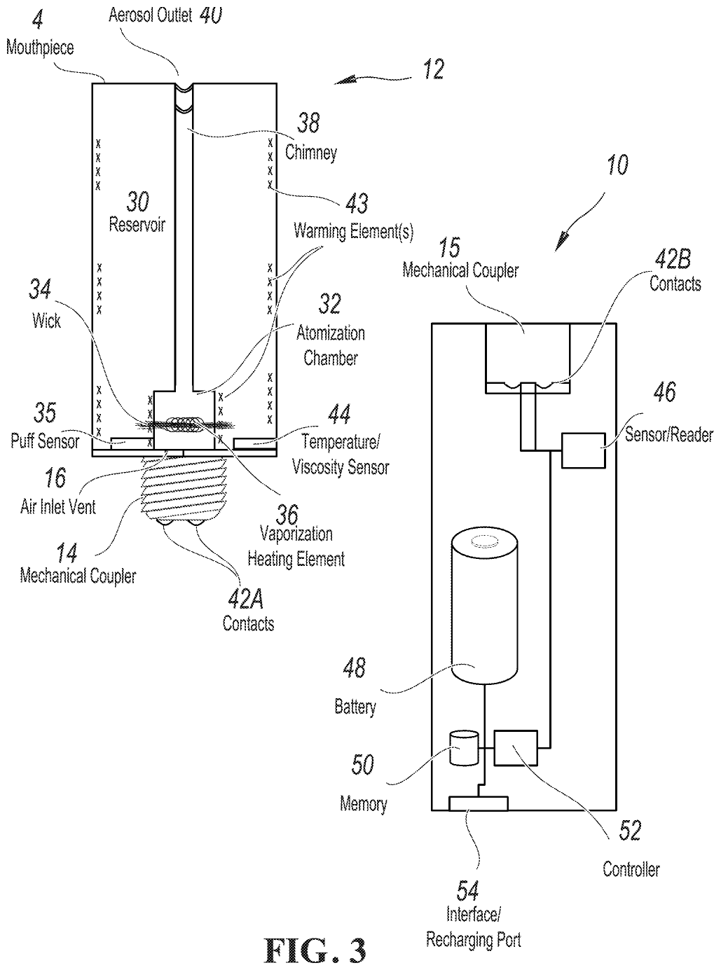

Turning to the illustrated example implementation, FIG. 1 is a perspective view of a personal vaporizer. While illustrated in the form factor of an electronic cigarette, the concepts herein could be applied to other types of personal vaporizers such as e-hookahs, vape kits, vape pens, etc. The example personal vaporizer 2 includes a housing having a first elongated portion 10 and a second elongated portion 12. The second elongated portion 12, also referred to as the “cartridge” in certain illustrative implementations, includes a mouthpiece end 4, which has an acrosol outlet (depicted in FIG. 3) for drawing air through the cartridge 12. The first elongated portion 10 and the second elongated portion 12 are removably joined together with a mechanical coupler 14. One or more air inlet vents 16 are provided about the coupler 14 for allowing airflow into the cartridge 12 when the user draws air through the personal vaporizer 2. The first elongated portion 10 includes a tip end 6, which in the illustrative implementation, is fabricated from a translucent material enabling the transmission of light therethrough. Within the second elongated portion 12 is disposed a liquid reservoir (not fully shown). In some implementations, the liquid reservoir includes a clear or translucent window 13 to the exterior of the housing 12 for visually determining the liquid level 15 within the liquid reservoir.

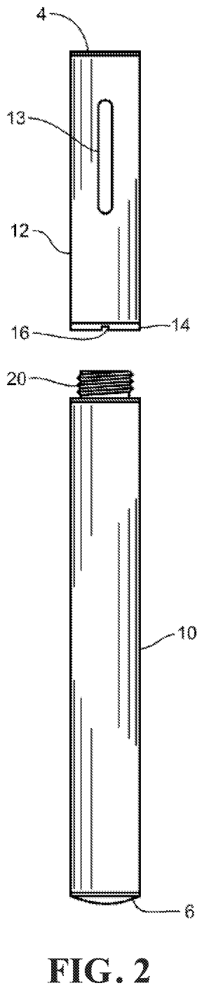

FIG. 2 depicts a side view drawing, respectively, of a cartridge portion 12 and a power supply portion 10 of a personal vaporizer 2 according to an illustrative embodiment of the present invention. The mechanical coupler 14 can have two parts, one that is part of the cartridge portion 12 and one that is part of the power supply portion 10, e.g., one part being female and configured to receive the other, male, part. The mechanical coupler can be, for example, threads, a lug/channel connector, a recessed magnetic connector or other suitable means for coupling the two portions of the personal vaporizer 2. FIG. 2 shows the mechanical coupling 14 portion on the power supply portion 10 in the form of a threaded extension 20 of the housing that engages female threads of the mechanical coupler 14 portion on the cartridge portion 12. In some implementations (as shown below and discussed with reference to in FIG. 3), the cartridge 12 can include a threaded or male portion, which engages with female threads of the power supply portion 10. In addition, an electrical connection can also be facilitated in the connection between the mechanical coupler 14 parts (as shown in more detail below with respect to FIG. 3). The power supply portion 10 can include one or more circuits for controlling operations of the cartridge portion 12. The circuits can be analog or digital and can include, for example, a microcontroller and various sensors to enable operation of the personal vaporizer 2. In this example illustration, the cartridge portion 12 can thus be installed, uninstalled, and replaced as needed. The cartridge portion contains the liquid reservoir and window 13 provides the visual indication as to the liquid remaining.

FIG. 3 illustrates a schematic diagram of some internal components of a personal vaporizer cartridge 12 and power supply 10.

Cartridge 12 includes a reservoir 30 and an atomization chamber 32. The atomization chamber 32 receives a primary substance in liquid form from the reservoir 30 via the wick 34. The wick 34 can be a fibrous bundle that draws liquid via capillary action from the reservoir 30. The wick 34 extends from the primary reservoir into the atomization chamber 32. It can be formed of a heat-resistant wicking material, such as aramid, fluorocarbon, sulfide, melamine, polyimide, carbon, glass fibers, or any combination thereof. An atomizer 36 can be a resistive coil that generates heat when electrical current passes through it. The atomizer 36 can be supplied with electrical power from the power supply portion 10 of the personal vaporizer. The atomizer 36 is located proximal to the wick 34 (in the example illustrated in FIG. 3 it is wrapped around the wick 34). Atomizer 36 heats the liquid carried from the primary reservoir 38 by the wick 34 and atomizes the primary substance which mixes with air in the atomization chamber to form an acrosol. One or more air inlet vents 16 near the bottom of the cartridge 12 allow airflow from the air inlet vent 16, through the atomization chamber 32 and out the chimney 38.

Chimney 38 provides a flow path from the air inlet vent 16, through the atomization chamber 32, and out the aerosol outlet 40 in the mouthpiece 4 portion of the cartridge 12. Mechanical coupler 14, illustrated as a threaded nipple, can include one or more electrical contacts 42A, which are configured to mate with corresponding contacts 42B on the power supply 10. In some implementations, the mechanical coupler 14 can be another type of coupler (e.g., a snap fit, pin and groove, magnetic, etc.). These contacts 42A can provide an electrical flow path from the battery 48, via the controller 52, through the atomizer 36. In some implementations, contacts 42A are a simple two pin system, with a positive and a common connection. In some implementations, contacts 42A are more complex, and can include, for example, serial connections, dedicated transmit/receive connections, or other configurations. Cartridge 12 can include one or more puff sensors 35 which can be, for example, a microphone, or pressure sensor, that transmits a “puff” signal to the controller to enable the power supply 10 to activate the atomizer 36 when a user induces airflow through the cartridge 12. In some implementations, sensor data is transmitted from the cartridge 12 to the power supply 10 wirelessly, e.g., using Bluetooth Low Energy, or ZigBee. In some implementations, sensor data (e.g. temperature data, puff data, or other information) is transmitted via contacts 42A and 42B.

In addition to a pressure or puff sensor 35, a temperature sensor 44 or viscosity sensor 44 can be provided. The temperature sensor 44 can be a thermistor, resistive sensor, resistance temperature detector (RTD), or other device that provides a signal that is a function of the temperature at the sensor. In some implementations the temperature sensor 44 is a passive device, and controller 52 or sensor/reader 46 (as described below) interrogate or supply power or a signal to temperature sensor 44, which modifies that signal based on the sensed temperature. While illustrated at the bottom of the cartridge 12, the temperature sensor 44 can be located near the top, on the sides, or elsewhere within the reservoir 30. Further, multiple temperature sensors 44 can be provided and can measure temperature at various locations within cartridge 12. In some instances, an external temperature sensor can measure the ambient air or environment temperature in addition to or alternatively to the internal fluid temperature.

Warming heaters 43 are provided throughout the cartridge 12. In the illustrated example warming heaters 43 are positioned around the inside of the outside wall of the reservoir 30 and around the atomization chamber 32. In some implementations, the warming heaters 43 arc only positioned in one location (e.g., on the atomization chamber). Warming heaters 43 on the exterior wall of the reservoir 30 can provide general heat to the bulk of the fluid within reservoir 30. Warming heaters 43 located on the atomization chamber 32 can ensure there is good flow into and around the wick intake area by maintaining fluid in the intake area at a temperature that has a low enough viscosity to readily flow into the wick. In general, warming heat can be applied to fluid in the reservoir to maintain the viscosity of the fluid below a certain target and ensure favorable flow properties. In some implementations, the warming heaters 43 are a single element that wraps or spirals around both the outside and inside of the reservoir. In some implementations, multiple separate warming heaters 43 are used, each with an independent conductor and independently activated. The warming heaters 43 can be a resistive coil that is configured to generate heat when electrical current is passed through it. In some implementations, the warming heater 43 can be constructed with physical properties (e.g., resistance, length, thickness, etc.) that ensure it does not exceed a safe temperature during normal operation when supplied with power from the power supply portion 10, but still heats the fluid in the reservoir sufficiently to maintain a reduced viscosity. For example, when the fluid in the reservoir has a boiling point of 50° C., the warming heaters 43 can be configured not to exceed 25° C., or 40° C. Alternatively, if plastics are involved in the construction of the reservoir, the warming heaters 43 can be designed to ensure they do not melt any structural components, and do not exceed, for example, 70° C. Safe temperature can be a temperature below which there is limited or no risk of structural damage to the device, and the fluid inside is not significantly chemically altered or does not evaporate.

Power supply 10 includes a complementary mechanical coupler 15 and complementary contacts 42B which can receive and couple to mechanical coupler 14 and contacts 42A, completing an electrical connection and enabling power transfer and communication between power supply 10 and cartridge 12. In some implementations, the mechanical coupler 15 are threads that engage the threaded nipple of mechanical coupler 14 and physically support the cartridge 12. A battery 48 supplies electrical power to power supply 10, and can be rechargeable (e.g., via interface/charging port 54).

A memory 50 can store instructions for controller 52, and can be for example, a flash memory, or EEPROM, or other memory type. Memory 50 can represent a single memory or multiple memories. The memory 50 can include any memory or database module and can take the form of volatile or non-volatile memory including, without limitation, magnetic media, optical media, random access memory (RAM), read-only memory (ROM), removable media, or any other suitable component. In general, memory 50 stores operating instructions for controller 52, and can include a database of cartridge types and settings. For example, memory 50 can store a database of operation settings, including heat intensity, duration, and frequency associated with a number of different cartridges. In some implementations, the controller 52 can periodically update this database by communicating with an external system via interface 54. Interface 54 can be a serial interface such as a universal serial bus (USB) type A, C, micro or mini, or other connection. In some implementations, interface 54 serves a dual purpose of providing external communications to power supply 10, as well as electrical power for recharging battery 48.

Controller 52 generally controls power supplied to the contacts 42B and thus to atomizer 36. In some implementations, controller 52 receives additional sensor inputs. For example, controller 52 can receive a signal corresponding to whether a cartridge is installed on power supply 10, and if not, prevent power from being sent to contacts 52B. In another example, controller 52 receives a “puff” signal from one or more sensors in cartridge 12 and uses the puff signal in addition to the cartridge type in order to determine how much power to supply to contacts 42B.

The controller 52 can be used to control operation of warming heaters 43 in addition to the atomizer 36. In some implementations, controller 52 provides power to warming heaters 43 simultaneously with the atomizer 36. That is, every time the user puffs or every time the puff sensor 35 is triggered, current is applied to both the atomizer 36 as well as the warming heaters 43. In some implementations, the controller 52 operates the warming heaters 43 independently of the atomizer 36. For example, the controller can receive an ambient temperature from sensor/reader 46, and/or temperature sensor 44 and can periodically apply power to warming heaters 43 to maintain the fluid in the reservoir 30 above a desired temperature and therefore below a target viscosity. Maintaining the fluid in the reservoir 30 below the target viscosity ensures it flows freely throughout the reservoir 30 and can readily enter or flow along the wick 34. The sensor/reader 46 can be a separate sensor located on the power supply 10, or can be a part of, or component used in reading parameters from sensors (e.g., temperature sensor 44) installed in the cartridge 12.

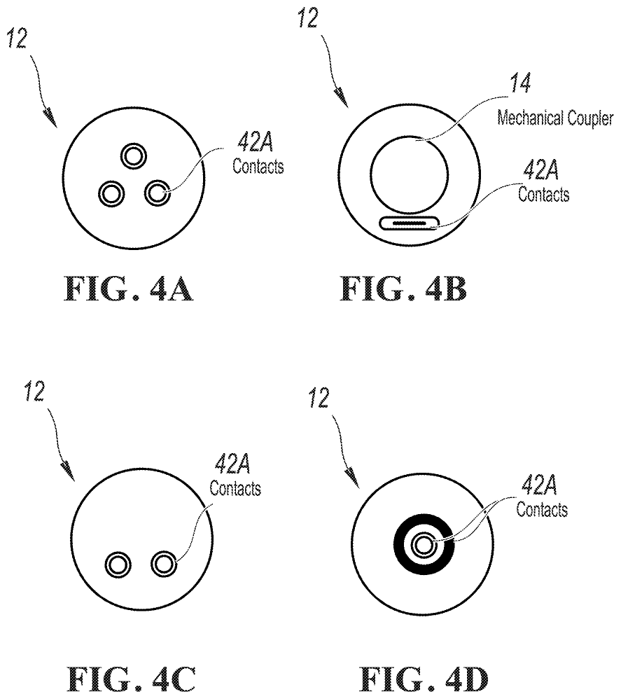

FIGS. 4A-4D illustrate example configurations of contacts for operation of a personal vaporizer cartridge. FIG. 4A illustrates a three-prong connecter with three contacts 42A that can be compression type contacts, or “pogo” pins. In some implementations, these contacts are spring loaded and, when the cartridge 12 is threaded otherwise mated onto the power supply portion, the contacts 42A are pressed against conductive plates in the power supply portion, compressing a spring to ensure positive connection between each pin and the plate. In the three-prong example of FIG. 4A, one prong can be a ground or common prong, one can be connected to the vaporization heating element 36 as shown in FIG. 3, and one can be connected to the warming clements 43 as shown in FIG. 3. This enables independent activation of the warming elements 43 and the heating element 36.

FIG. 4B shows an example set of contacts 42A in the form of a USB port—for example a USB type C connector. The USB connector can include multiple contacts which can perform the same functions as described in FIG. 4A plus additional ones. For example, USB-C typically includes 12 separate contact pins, which can be used for communication, timing, ground, power transfer, or other purposes. The contacts 42A of FIG. 4B can be a male or female USB connection, with the opposite installed on the power supply portion. In some implementations, when USB connections are used, a magnetic mechanical coupler 14 is used instead of a threaded coupler to avoid the necessity of rotating the cartridge 12 relative to the power supply. While USB-C is illustrated, other USB ports are feasible, including USB-A, USB-B, Mini USB, Micro USB, or other serial connections.

FIG. 4C illustrates a two-prong layout. In FIG. 4C, one contact 42A can be for the vaporization heating element, while the other is for the warming elements. In this configuration, the chassis, or case of the device can act as a common or ground connection between the cartridge 12 and the power supply. In some implementations, the heating element and the warming elements can be connected in series and only require a single contact. In these implementations, one of the pins can be ground.

FIG. 4D illustrates a concentric contact layout. One or more rings of conductive material can be isolated by insulators and enable mating with similar contacts on the power supply. An advantage of the concentric contacts is that they function regardless of the relative rotation angle between the cartridge 12 and the power supply. That is, the cartridge 12 can be rotate relative to the power supply without interrupting the connection, there is no particular alignment requirement for the contacts 42A to function.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

1. An apparatus comprising:
cartridge for a personal vaporizer comprising:
a reservoir configured to contain a fluid to be vaporized;
a first heater configured to vaporize the fluid, the first heater located in an atomization chamber;
a wick configured to deliver the fluid to the first heater;
a second heater configured to warm the fluid in the reservoir without vaporizing the fluid; and
a set of contacts configured to receive power and deliver the power to the first heater and the second heater.

2. The apparatus of claim 1, the second heater is configured to warm the fluid in the reservoir to no greater than 70° C.

3. The apparatus of claim 1, comprising a temperature sensor configured to generate a signal based on the temperature of the fluid in the reservoir but outside the atomization chamber.

4. The apparatus of claim 3, wherein the second heater is positioned on an outer surface of the atomization chamber, and wherein the atomization chamber is within the reservoir.

5. The apparatus of claim 3 comprising:
a power supply portion comprising:
a battery;
a controller configured to:
receive the generated signal; and
deliver electrical power from the battery to the second heater to cause the second heater to warm the fluid.

6. The apparatus of claim 5, wherein the controller is configured to warm the fluid to a temperature less than 70° C.

7. The apparatus of claim 5, wherein the controller is configured to warm the fluid to a temperature of at least 26° C.

8. The apparatus of claim 5, wherein the controller delivers electrical power to the second heater in an amount inversely proportional to the generated signal.

9. The apparatus of claim 5, wherein the cartridge portion and the power supply portion are removably coupled together by a coupler, and wherein the coupler comprises a set of electrical contacts.

10. The apparatus of claim 9, wherein a first contact of the set of contacts is connected to the first heater, and a second contact of the set of contacts is connected to the second heater.

11. The apparatus of claim 9, wherein a third contact of the set of contacts is connected to the temperature sensor.

12. The apparatus of claim 1, comprising a puff sensor configured to detect when airflow passes through the cartridge and output a puff signal.

13. The apparatus of claim 1, wherein the second heater comprises two conductors, a first conductor disposed along an outer diameter of the reservoir, and a second conductor disposed along an outer surface of the atomization chamber and along an inner diameter of the reservoir.

14. A method for atomizing fluid in a personal vaporizer comprising:
storing the fluid in a reservoir;
heating the fluid with a second heater without vaporizing the fluid to reduce a viscosity of the fluid;
allowing the fluid to flow from the reservoir along a wick into an atomization chamber; and
heating the fluid with a first heater to atomize the fluid from the wick.

15. The method of claim 14, wherein heating the fluid with the first heater comprises heating the fluid with the first heater in response to detecting airflow through the atomization chamber.

16. The method of claim 14, wherein heating the fluid with the second heater comprises heating the fluid to a temperature that does not exceed 70 C.

17. The method of claim 14, wherein heating the fluid with the second heater comprises heating the fluid with the second heater based on a measured temperature of the fluid.

18. The method of claim 14 comprising coupling a cartridge portion with a power supply portion of the personal vaporizer.
